(19) United States
(12) Patent Application Publication
(10) Pub. No.: US 2020/0031135 A1
(43) Pub. Date: Jan. 30, 2020

(54) FLUID EJECTION DEVICE

(71) Applicant: HEWLETT-PACKARD DEVELOPMENT COMPANY, L.P., Spring, TX (US)

(72) Inventors: Tsuyoshi Yamashita, Corvallis, OR (US); Alexander Govyadinov, Corvallis, OR (US); Nick McGuinness, Corvallis, OR (US); Erik D Torniainen, Corvallis, OR (US); David P Markel, Corvallis, OR (US)

(73) Assignee: HEWLETT-PACKARD DEVELOPMENT COMPANY, L.P., Spring, TX (US)

(21) Appl. No.: 16/337,579

(22) PCT Filed: Jan. 23, 2017
(86) PCT No.: PCT/US2017/014563

§ 371 Date: Mar. 28, 2019

(51) Int. Cl. B41J 2/18

(52) U.S. Cl. CPC B41J 2/18

(57) ABSTRACT

A fluid ejection device includes a fluid slot, two laterally adjacent fluid ejection chambers each communicated with the fluid slot and having a drop ejecting element therein, and a fluid circulation path communicated with each of the two laterally adjacent fluid ejection chambers and having a fluid circulating element therein, with the two laterally adjacent fluid ejection chambers to concurrently eject drops of fluid therefrom such that the drops of fluid are to coalesce during flight.

### BACKGROUND

Fluid ejection devices, such as printheads in inkjet printing systems, may use thermal resistors or piezoelectric material membranes as actuators within fluidic chambers to eject fluid drops (e.g., ink) from nozzles, such that properly sequenced ejection of ink drops from the nozzles causes characters or other images to be printed on a print medium as the printhead and the print medium move relative to each other.

### BRIEF DESCRIPTION OF THE DRAWINGS

FIG. 1 is a block diagram illustrating one example of an inkjet printing system including an example of a fluid ejection device.

FIG. 2 is a schematic plan view illustrating an example of a portion of a fluid ejection device.

FIG. 3 is a schematic plan view illustrating an example of a portion of a fluid ejection device.

FIG. 4 is a schematic plan view illustrating an example of a portion of a fluid ejection device.

FIG. 5 is a schematic plan view illustrating an example of a portion of a fluid ejection device.

FIGS. 6A, 6B, 6C are schematic cross-sectional views illustrating an example of operation of the fluid ejection devices of FIGS. 2, 3, 4, 5.

FIG. 7 is a flow diagram illustrating an example of a method of operating a fluid ejection device.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure.

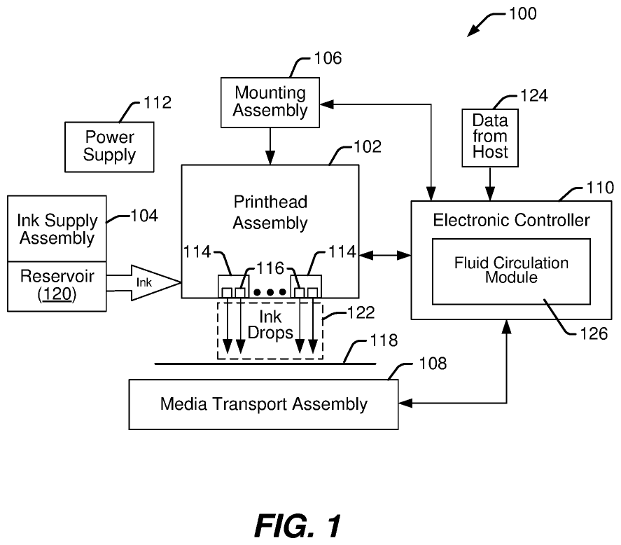

FIG. 1 illustrates one example of an inkjet printing system as an example of a fluid ejection device with fluid circulation, as disclosed herein. Inkjet printing system 100 includes a printhead assembly 102, an ink supply assembly 104, a mounting assembly 106, a media transport assembly 108, an electronic controller 110, and at least one power supply 112 that provides power to the various electrical components of inkjet printing system 100. Printhead assembly 102 includes at least one fluid ejection assembly 114 (printhead 114) that ejects drops of ink through a plurality of orifices or nozzles 116 toward a print medium 118 so as to print on print media 118.

Print media 118 can be any type of suitable sheet or roll material, such as paper, card stock, transparencies, Mylar, and the like, and may include rigid or semi-rigid material, such as cardboard or other panels. Nozzles 116 are typically arranged in one or more columns or arrays such that properly sequenced ejection of ink from nozzles 116 causes characters, symbols, and/or other graphics or images to be printed on print media 118 as printhead assembly 102 and print media 118 are moved relative to each other.

Ink supply assembly 104 supplies fluid ink to printhead assembly 102 and, in one example, includes a reservoir 120 for storing ink such that ink flows from reservoir 120 to printhead assembly 102. Ink supply assembly 104 and printhead assembly 102 can form a one-way ink delivery system or a recirculating ink delivery system. In a one-way ink delivery system, substantially all of the ink supplied to printhead assembly 102 is consumed during printing. In a recirculating ink delivery system, only a portion of the ink supplied to printhead assembly 102 is consumed during printing. Ink not consumed during printing is returned to ink supply assembly 104.

In one example, printhead assembly 102 and ink supply assembly 104 are housed together in an inkjet cartridge or pen. In another example, ink supply assembly 104 is separate from printhead assembly 102 and supplies ink to printhead assembly 102 through an interface connection, such as a supply tube. In either example, reservoir 120 of ink supply assembly 104 may be removed, replaced, and/or refilled. Where printhead assembly 102 and ink supply assembly 104 are housed together in an inkjet cartridge, reservoir 120 includes a local reservoir located within the cartridge as well as a larger reservoir located separately from the cartridge. The separate, larger reservoir serves to refill the local reservoir. Accordingly, the separate, larger reservoir and/or the local reservoir may be removed, replaced, and/or refilled.

Mounting assembly 106 positions printhead assembly 102 relative to media transport assembly 108, and media transport assembly 108 positions print media 118 relative to printhead assembly 102. Thus, a print zone 122 is defined adjacent to nozzles 116 in an area between printhead assembly 102 and print media 118. In one example, printhead assembly 102 is a scanning type printhead assembly. As such, mounting assembly 106 includes a carriage for moving printhead assembly 102 relative to media transport assembly 108 to scan print media 118. In another example, printhead assembly 102 is a non-scanning type printhead assembly. As such, mounting assembly 106 fixes printhead assembly 102 at a prescribed position relative to media transport assembly 108. Thus, media transport assembly 108 positions print media 118 relative to printhead assembly 102.

Electronic controller 110 typically includes a processor, firmware, software, one or more memory components including volatile and non-volatile memory components, and other printer electronics for communicating with and controlling printhead assembly 102, mounting assembly 106, and media transport assembly 108. Electronic controller 110 receives data 124 from a host system, such as a computer, and temporarily stores data 124 in a memory. Typically, data 124 is sent to inkjet printing system 100 along an electronic, infrared, optical, or other information transfer path. Data 124 represents, for example, a document and/or file to be printed. As such, data 124 forms a print job for inkjet printing system 100 and includes one or more print job commands and/or command parameters.

In one example, electronic controller 110 controls printhead assembly 102 for ejection of ink drops from nozzles 116. Thus, electronic controller 110 defines a pattern of ejected ink drops which form characters, symbols, and/or other graphics or images on print media 118. The pattern of ejected ink drops is determined by the print job commands and/or command parameters.

Printhead assembly 102 includes one or more printheads 114. In one example, printhead assembly 102 is a wide-array or multi-head printhead assembly. In one implementation of a wide-array assembly, printhead assembly 102 includes a carrier that carries a plurality of printheads 114, provides electrical communication between printheads 114 and electronic controller 110, and provides fluidic communication between printheads 114 and ink supply assembly 104.

In one example, inkjet printing system 100 is a drop-on-demand thermal inkjet printing system wherein printhead 114 is a thermal inkjet (TIJ) printhead. The thermal inkjet printhead implements a thermal resistor ejection element in an ink chamber to vaporize ink and create bubbles that force ink or other fluid drops out of nozzles 116. In another example, inkjet printing system 100 is a drop-on-demand piezoelectric inkjet printing system wherein printhead 114 is a piezoelectric inkjet (PIJ) printhead that implements a piezoelectric material actuator as an ejection element to generate pressure pulses that force ink drops out of nozzles 116.

In one example, electronic controller 110 includes a flow circulation module 126 stored in a memory of controller 110. Flow circulation module 126 executes on electronic controller 110 (i.e., a processor of controller 110) to control the operation of one or more fluid actuators integrated as pump elements within printhead assembly 102 to control circulation of fluid within printhead assembly 102.

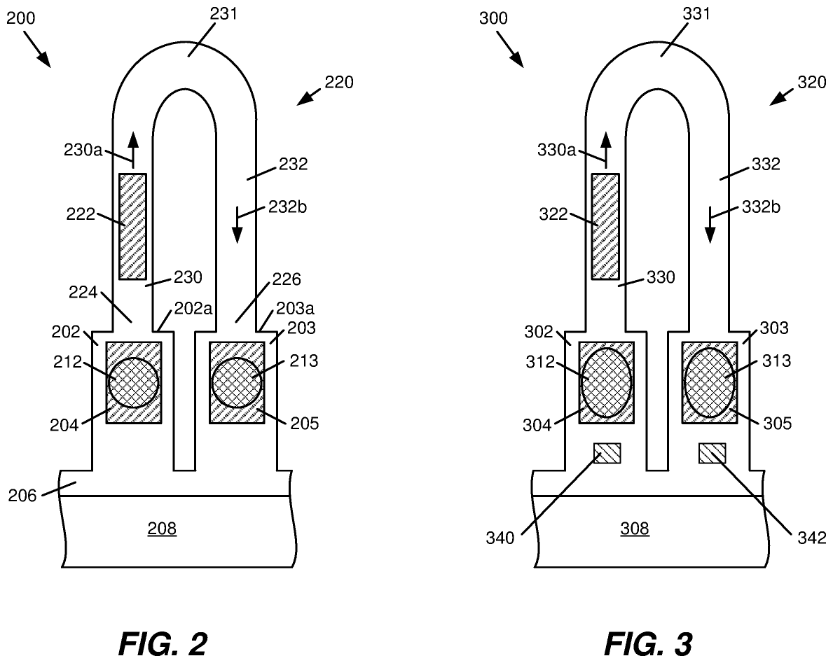

FIG. 2 is a schematic plan view illustrating an example of a portion of a fluid ejection device 200. Fluid ejection device 200 includes a first fluid ejection chamber 202 and a corresponding drop ejecting element 204 formed in, provided within, or communicated with fluid ejection chamber 202, and a second fluid ejection chamber 203 and a corresponding drop ejecting element 205 formed in, provided within, or communicated with fluid ejection chamber 203. In one example, and as further described below, fluid ejection chambers 202 and 203 are laterally adjacent each other.

In one example, fluid ejection chambers 202 and 203 and drop ejecting elements 204 and 205 are formed on a substrate 206 which has a fluid (or ink) feed slot 208 formed therein such that fluid feed slot 208 provides a supply of fluid (or ink) to fluid ejection chambers 202 and 203 and drop ejecting elements 204 and 205. Fluid feed slot 208 includes, for example, a hole, passage, opening, convex geometry or other fluidic architecture formed in or through substrate 206 by which or through which fluid is supplied to fluid ejection chambers 202 and 203. Fluid feed slot 208 may include one (i.e., a single) or more than one (e.g., a series of) such hole, passage, opening, convex geometry or other fluidic architecture that communicates fluid with one (i.e., a single) or more than one fluid ejection chamber, and may be of circular, non-circular, or other shape. Substrate 206 may be formed, for example, of silicon, glass, or a stable polymer.

In one example, fluid ejection chambers 202 and 203 are formed in or defined by a barrier layer (not shown) provided on substrate 206, such that fluid ejection chambers 202 and 203 each provide a “well” in the barrier layer. The barrier layer may be formed, for example, of a photoimageable epoxy resin, such as SU8. In one example, a nozzle or orifice layer (not shown) is formed or extended over the barrier layer such that nozzle openings or orifices 212 and 213 formed in the orifice layer communicate with respective fluid ejection chambers 202 and 203.

In one example, as illustrated in FIG. 2, nozzle openings or orifices 212 and 213 are of the same size and the same shape. As such, nozzle openings or orifices 212 and 213 enable the ejection of drops of the same size (weight). Nozzle openings or orifices 212 and 213 may be of a circular, non-circular, or other shape. Although illustrated as being of the same size, nozzle openings or orifices 212 and 213 may be of different sizes (for example, different diameters, effective diameters, or maximum dimensions). Although illustrated as being of the same shape, nozzle openings or orifices 212 and 213 may be of different shapes (for example, one circular, one non-circular). In addition, although illustrated as being of the same shape and same size, drop ejecting elements 204 and 205 and corresponding fluid ejection chambers 202 and 203 may be of different shapes, and may be of different sizes.

Drop ejecting elements 204 and 205 can be any device capable of ejecting fluid drops through corresponding nozzle openings or orifices 212 and 213. Examples of drop ejecting elements 204 and 205 include thermal resistors or piezoelectric actuators. A thermal resistor, as an example of a drop ejecting element, may be formed on a surface of a substrate (substrate 206), and may include a thin-film stack including an oxide layer, a metal layer, and a passivation layer such that, when activated, heat from the thermal resistor vaporizes fluid in corresponding fluid ejection chamber 202 or 203, thereby causing a bubble that ejects a drop of fluid through corresponding nozzle opening or orifice 212 or 213. A piezoelectric actuator, as an example of a drop ejecting element, generally includes a piezoelectric material provided on a moveable membrane communicated with corresponding fluid ejection chamber 202 or 203 such that, when activated, the piezoelectric material causes deflection of the membrane relative to corresponding fluid ejection chamber 202 or 203, thereby generating a pressure pulse that ejects a drop of fluid through corresponding nozzle opening or orifice 212 or 213.

As illustrated in the example of FIG. 2, fluid ejection device 200 includes a fluid circulation path or channel 220 and a fluid circulating element 222 formed in, provided within, or communicated with fluid circulation channel 220. Fluid circulation channel 220 is open to and communicates at one end 224 with fluid ejection chamber 202 and is open to and communicates at another end 226 with fluid ejection chamber 203. In one example, end 224 of fluid circulation channel 220 communicates with fluid ejection chamber 202 at an end 202a of fluid ejection chamber 202, and end 226 of fluid circulation channel 220 communicates with fluid ejection chamber 203 at an end 203a of fluid ejection chamber 203.

In one example, fluid circulating element 222 is provided in, provided along, or communicated with fluid circulation channel 220 between end 224 and end 226 such that fluid circulating element 222 is provided in, provided along, or communicated with fluid circulation channel 220 between fluid ejection chamber 202 and fluid ejection chamber 203. More specifically, in one example, fluid circulating element 222 is provided in, provided along, or communicated with fluid circulation channel 220 adjacent end 224. In other examples, a position of fluid circulating element 222 may vary along fluid circulation channel 220.

Fluid circulating element 222 forms or represents an actuator to pump or circulate (or recirculate) fluid through fluid circulation channel 220. As such, fluid from fluid feed slot 208 circulates (or recirculates) through fluid circulation channel 220 and fluid ejection chambers 202 and 203 based on flow induced by fluid circulating element 222. In one example, circulating (or recirculating) fluid through fluid ejection chambers 202 and 203 helps to reduce ink blockage and/or clogging in fluid ejection device 200.

In the example illustrated in FIG. 2, drop ejecting elements 204 and 205 and fluid circulating element 222 are each thermal resistors. Each of the thermal resistors may include, for example, a single resistor, a split resistor, a comb resistor, or multiple resistors. A variety of other devices, however, can also be used to implement drop ejecting elements 204 and 205 and fluid circulating element 222 including, for example, a piezoelectric actuator, an electrostatic (MEMS) membrane, a mechanical/impact driven membrane, a voice coil, a magneto-strictive drive, and so on.

In one example, fluid circulation channel 220 includes a path or channel portion 230 communicated with fluid ejection chamber 202, and a path or channel portion 232 communicated with fluid ejection chamber 203. As such, in one example, fluid in fluid circulation channel 220 circulates (or recirculates) between fluid ejection chamber 202 and fluid ejection chamber 203 through channel portion 230 and channel portion 232.

In one example, fluid circulation channel 220 forms a fluid circulation (or recirculation) loop between fluid feed slot 208, fluid ejection chamber 202, and fluid ejection chamber 203. For example, fluid from fluid feed slot 208 circulates (or recirculates) through fluid ejection chamber 202, through fluid circulation channel 220, and through fluid ejection chamber 203 back to fluid feed slot 208. More specifically, fluid from fluid feed slot 208 circulates (or recirculates) through fluid ejection chamber 202, through channel portion 230, through channel portion 232, and through fluid ejection chamber 203 back to fluid feed slot 208.

As illustrated in the example of FIG. 2, fluid circulating element 222 is formed in, provided within, or communicated with channel portion 230 of fluid circulation channel 220, and forms an asymmetry to fluid circulation channel 220 whereby a fluid flow distance between fluid circulating element 222 and fluid ejection chamber 202 is less than a fluid flow distance between fluid circulating element 222 and fluid ejection chamber 203. As such, in one example, channel portion 230 directs fluid in a first direction, as indicated by arrow 230a, and channel portion 232 directs fluid in a second direction opposite the first direction, as indicated by arrow 232b. More specifically, in one example, fluid circulation channel 220 directs fluid in a first direction (arrow 230a) between fluid ejection chamber 202 and fluid ejection chamber 203, and directs fluid in a second direction (arrow 232b) opposite the first direction between fluid ejection chamber 202 and fluid ejection chamber 203. Thus, in one example, fluid circulating element 222 creates an average or net fluid flow in fluid circulation channel 220 between fluid ejection chamber 202 and fluid ejection chamber 203.

In one example, to provide fluid flow in the first direction indicated by arrow 230a and the second, opposite direction indicated by arrow 232b, fluid circulation channel 220 includes a channel loop 231. As such, in one example, fluid circulation channel 220 directs fluid in the first direction (arrow 230a) between fluid ejection chamber 202 and channel loop 231, and in the second direction (arrow 232b) between channel loop 231 and fluid ejection chamber 203. In one example, channel loop 231 includes a U-shaped portion of fluid circulation channel 220 such that a length (or portion) of channel portion 230 and a length (or portion) of channel portion 232 are spaced from and oriented substantially parallel with each other.

In one example, a width of channel portion 230 and a width of channel portion 232 are substantially equal. In addition, a length of channel portion 230 and a length of channel portion 232 are substantially equal. Furthermore, as illustrated in the example of FIG. 2, a width of channel portion 230 is less than a width of fluid ejection chamber 202, and a width of channel portion 232 is less than a width of fluid ejection chamber 203. In other examples, channel portions 230 and 232 (including sections, segments or regions thereof) may be of different widths, and may be of different lengths.

FIG. 3 is a schematic plan view illustrating an example of a portion of a fluid ejection device 300. Similar to fluid ejection device 200, fluid ejection device 300 includes a first fluid ejection chamber 302 with a corresponding drop ejecting element 304, and a second fluid ejection chamber 303 with a corresponding drop ejecting element 305, such that nozzle openings or orifices 312 and 313 communicate with respective fluid ejection chambers 302 and 303. In one example, and as further described below, fluid ejection chambers 302 and 303 are laterally adjacent each other.

In one example, nozzle openings or orifices 312 and 313 are each of the same non-circular shape, including, for example, a non-circular bore, and are each of the same size. As such, nozzle openings or orifices 312 and 313 enable the ejection of drops of the same size (weight). Although illustrated as being of the same shape and the same size, nozzle openings or orifices 312 and 313, and drop ejecting elements 304 and 305, may be of different shapes, and may be of different sizes.

In one example, and similar to fluid ejection device 200, fluid ejection device 300 includes a fluid circulation path or channel 320 with a corresponding fluid circulating element 322, with fluid circulation channel 320 including a path or channel portion 330 communicated with fluid ejection chamber 302, and a path or channel portion 332 communicated with fluid ejection chamber 303. Similar to fluid circulation channel 220 of fluid ejection device 200, fluid circulation channel 320 of fluid ejection device 300 forms a fluid circulation (or recirculation) loop between fluid feed slot 308, fluid ejection chamber 302, and fluid ejection chamber 303. For example, fluid from fluid feed slot 308 circulates (or recirculates) through fluid ejection chamber 302, through fluid circulation channel 320, and through fluid ejection chamber 303 back to fluid feed slot 308. More specifically, fluid from fluid feed slot 308 circulates (or recirculates) through fluid ejection chamber 302, through channel portion 330, through channel portion 332, and through fluid ejection chamber 303 back to fluid feed slot 308.

In addition, and similar to fluid circulating element 222 of fluid ejection device 200, fluid circulating element 322 is provided in, provided along, or communicated with fluid circulation channel 320 between fluid ejection chamber 302 and fluid ejection chamber 303. More specifically, in one example, fluid circulating element 322 is formed in, provided within, or communicated with channel portion 330 of fluid circulation channel 320, and forms an asymmetry to fluid circulation channel 320 whereby a fluid flow distance between fluid circulating element 322 and fluid ejection chamber 302 is less than a fluid flow distance between fluid circulating element 322 and fluid ejection chamber 303. As such, in one example, channel portion 330 directs fluid in a first direction, as indicated by arrow 330a, and channel portion 332 directs fluid in a second direction opposite the first direction, as indicated by arrow 332b. Thus, in one example, fluid circulating element 322 creates an average or net fluid flow in fluid circulation channel 320 between fluid ejection chamber 302 and fluid ejection chamber 303. Furthermore, in one example, and similar to fluid circulation channel 220 of fluid ejection device 200, fluid circulation channel 320 includes a channel loop 331 wherein channel loop 331 includes a U-shaped portion of fluid circulation channel 320.

As illustrated in the example of FIG. 3, fluid ejection device 300 includes an object tolerant architecture 340 between fluid feed slot 308 and fluid ejection chamber 302, and an object tolerant architecture 342 between fluid feed slot 308 and between fluid ejection chamber 303. Object tolerant architecture 340 and object tolerant architecture 342 include, for example, a pillar, a column, a post or other structure (or structures). As such, object tolerant architecture 340 and object tolerant architecture 342 form “islands” which allow fluid to flow past while preventing objects, such as air bubbles or particles (e.g., dust, fibers), from flowing into fluid ejection chamber 302 from fluid feed slot 308, and into fluid ejection chamber 303 from fluid feed slot 308. Such objects, if allowed to enter fluid ejection chamber 302 or fluid ejection chamber 303, may affect the performance of fluid ejection device 300, including, for example, the performance of drop ejecting element 304 or drop ejecting element 305.

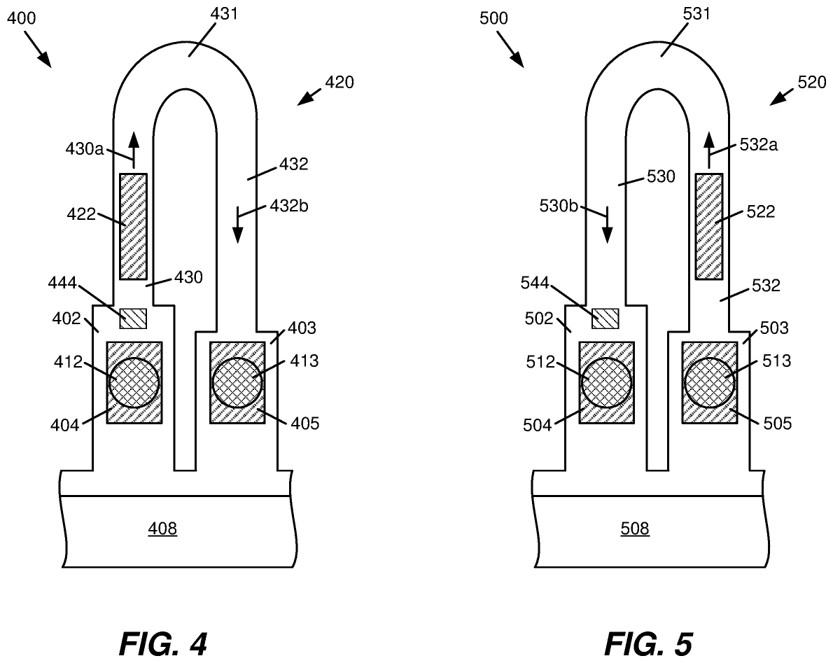

FIG. 4 is a schematic plan view illustrating an example of a portion of a fluid ejection device 400. Similar to fluid ejection device 200, fluid ejection device 400 includes a first fluid ejection chamber 402 with a corresponding drop ejecting element 404, and a second fluid ejection chamber 403 with a corresponding drop ejecting element 405, such that nozzle openings or orifices 412 and 413 communicate with respective fluid ejection chambers 402 and 403. In one example, and as further described below, fluid ejection chambers 402 and 403 are laterally adjacent each other.

In one example, nozzle openings or orifices 412 and 413 are each of the same shape and the same size. As such, nozzle openings or orifices 412 and 413 enable the ejection of drops of the same size (weight). Nozzle openings or orifices 412 and 413 may be of a circular, non-circular, or other shape. Although illustrated as being of the same shape and the same size, nozzle openings or orifices 412 and 413, and drop ejecting elements 404 and 405, may be of different shapes, and may be of different sizes.

In one example, and similar to fluid ejection device 200, fluid ejection device 400 includes a fluid circulation path or channel 420 with a corresponding fluid circulating element 422, with fluid circulation channel 420 including a path or channel portion 430 communicated with fluid ejection chamber 402, and a path or channel portion 432 communicated with fluid ejection chamber 403. Similar to fluid circulation channel 220 of fluid ejection device 200, fluid circulation channel 420 of fluid ejection device 400 forms a fluid circulation (or recirculation) loop between fluid feed slot 408, fluid ejection chamber 402, and fluid ejection chamber 403. For example, fluid from fluid feed slot 408 circulates (or recirculates) through fluid ejection chamber 402, through fluid circulation channel 420, and through fluid ejection chamber 403 back to fluid feed slot 408. More specifically, fluid from fluid feed slot 408 circulates (or recirculates) through fluid ejection chamber 402, through channel portion 430, through channel portion 432, and through fluid ejection chamber 403 back to fluid feed slot 408.

In addition, and similar to fluid circulating element 222 of fluid ejection device 200, fluid circulating element 422 is provided in, provided along, or communicated with fluid circulation channel 420 between fluid ejection chamber 402 and fluid ejection chamber 403. More specifically, in one example, fluid circulating element 422 is formed in, provided within, or communicated with channel portion 430 of fluid circulation channel 420, and forms an asymmetry to fluid circulation channel 420 whereby a fluid flow distance between fluid circulating element 422 and fluid ejection chamber 402 is less than a fluid flow distance between fluid circulating element 422 and fluid ejection chamber 403. As such, in one example, channel portion 430 directs fluid in a first direction, as indicated by arrow 430a, and channel portion 432 directs fluid in a second direction opposite the first direction, as indicated by arrow 432b. Thus, in one example, fluid circulating element 422 creates an average or net fluid flow in fluid circulation channel 420 between fluid ejection chamber 402 and fluid ejection chamber 403. Furthermore, in one example, and similar to fluid circulation channel 220 of fluid ejection device 200, fluid circulation channel 420 includes a channel loop 431 wherein channel loop 431 includes a U-shaped portion of fluid circulation channel 420.

As illustrated in the example of FIG. 4, fluid ejection device 400 includes an object tolerant architecture 444. Object tolerant architecture 444 includes, for example, a pillar, a column, a post or other structure (or structures) formed or provided between fluid ejection chamber 402 and fluid circulation channel 420, including, more specifically, between drop ejecting element 404 and fluid circulating element 422. As such, object tolerant architecture 444 is provided “upstream” or before fluid circulating element 422 (relative to a direction of fluid flow through fluid circulation channel 420). In one example, object tolerant architecture 444 is formed within fluid ejection chamber 402 opposite of fluid feed slot 408.

In one example, object tolerant architecture 444 forms an “island” which allows fluid to flow past and into (or from) fluid circulation channel 420 while preventing objects, such as air bubbles or particles (e.g., dust, fibers), from flowing into (or from) fluid circulation channel 420. For example, object tolerant architecture 444 helps to prevent air bubbles and/or particles from entering fluid circulation channel 420, and entering fluid ejection chamber 403, from fluid ejection chamber 402, and helps to prevent air bubbles and/or particles from entering fluid ejection chamber 402 from fluid circulation channel 420. Such objects, if allowed to enter fluid circulation channel 420, or fluid ejection chamber 402 or fluid ejection chamber 403, may affect the performance of fluid ejection device 400, including, for example, the performance of fluid circulating element 422, or drop ejecting element 404 or drop ejecting element 405. In addition, object tolerant architecture 444 helps to increase back pressure and, therefore, increase firing momentum of the ejection of drops from fluid ejection chamber 402 by helping to contain the drive energy during drop ejection. Furthermore, object tolerant architecture 444 helps to mitigate or minimize cross-talk between fluid ejection chamber 402 and fluid ejection chamber 403, and between fluid circulating element 422 and fluid ejection chamber 402.

FIG. 5 is a schematic plan view illustrating an example of a portion of a fluid ejection device 500. Similar to fluid ejection device 400, fluid ejection device 500 includes a first fluid ejection chamber 502 with a corresponding drop ejecting element 504, and a second fluid ejection chamber 503 with a corresponding drop ejecting element 505, such that nozzle openings or orifices 512 and 513 communicate with respective fluid ejection chambers 502 and 503. In one example, and as further described below, fluid ejection chambers 502 and 503 are laterally adjacent each other.

In one example, nozzle openings or orifices 512 and 513 are each of the same shape and the same size. As such, nozzle openings or orifices 512 and 513 enable the ejection of drops of the same size (weight). Nozzle openings or orifices 512 and 513 may be of a circular, non-circular, or other shape. Although illustrated as being of the same shape and the same size, nozzle openings or orifices 512 and 513, and drop ejecting elements 504 and 505, may be of different shapes, and may be of different sizes.

In one example, and similar to fluid ejection device 200, fluid ejection device 500 includes a fluid circulation path or channel 520 with a corresponding fluid circulating element 522, with fluid circulation channel 520 including a path or channel portion 530 communicated with fluid ejection chamber 502, and a path or channel portion 532 communicated with fluid ejection chamber 503. Similar to fluid circulation channel 220 of fluid ejection device 200, fluid circulation channel 520 forms a fluid circulation (or recirculation) loop between fluid feed slot 508, fluid ejection chamber 503, and fluid ejection chamber 502. For example, fluid from fluid feed slot 508 circulates (or recirculates) through fluid ejection chamber 503, through fluid circulation channel 520, and through fluid ejection chamber 502 back to fluid feed slot 508. More specifically, fluid from fluid feed slot 508 circulates (or recirculates) through fluid ejection chamber 503, through channel portion 532, through channel portion 530, and through fluid ejection chamber 502 back to fluid feed slot 508. In one example, and similar to fluid circulation channel 420 of fluid ejection device 400, fluid circulation channel 520 includes a channel loop 531 wherein channel loop 531 includes a U-shaped portion of fluid circulation channel 520.

As illustrated in the example of FIG. 5, fluid circulating element 522 is provided in, provided along, or communicated with fluid circulation channel 520 between fluid ejection chamber 502 and fluid ejection chamber 503. More specifically, in one example, fluid circulating element 522 is formed in, provided within, or communicated with channel portion 532 of fluid circulation channel 520, and forms an asymmetry to fluid circulation channel 520 whereby a fluid flow distance between fluid circulating element 522 and fluid ejection chamber 503 is less than a fluid flow distance between fluid circulating element 522 and fluid ejection chamber 502. As such, in one example, channel portion 532 directs fluid in a first direction, as indicated by arrow 532a, and channel portion 530 directs fluid in a second direction opposite the first direction, as indicated by arrow 530b. More specifically, in one example, fluid circulation channel 520 directs fluid in a first direction (arrow 532a) between fluid ejection chamber 503 and fluid ejection chamber 502, and directs fluid in a second direction (arrow 530b) opposite the first direction between fluid ejection chamber 503 and fluid ejection chamber 502, including in the first direction (arrow 532a) between fluid ejection chamber 503 and channel loop 531, and in the second direction (arrow 530b) between channel loop 531 and fluid ejection chamber 502. Thus, in one example, fluid circulating element 522 creates an average or net fluid flow in fluid circulation channel 520 between fluid ejection chamber 503 and fluid ejection chamber 502.

In one example, fluid ejection device 500 includes an object tolerant architecture 544. Object tolerant architecture 544 includes, for example, a pillar, a column, a post or other structure (or structures) formed or provided between fluid circulation channel 520 and fluid ejection chamber 502, including, more specifically, between fluid circulating element 522 and drop ejecting element 504. As such, object tolerant architecture 544 is provided “downstream” or after fluid circulating element 522 (relative to a direction of fluid flow through fluid circulation channel 520). In one example, object tolerant architecture 544 is formed within fluid ejection chamber 502 opposite of fluid feed slot 508.

In one example, object tolerant architecture 544 forms an “island” which allows fluid to flow past and from (or into) fluid circulation channel 520 while preventing objects, such as air bubbles or particles (e.g., dust, fibers), from flowing from (or into) fluid circulation channel 520. For example, object tolerant architecture 544 helps to prevent air bubbles and/or particles from entering fluid ejection chamber 502 from fluid circulation channel 520, and helps to prevent air bubbles and/or particles from entering fluid circulation channel 520, and entering fluid ejection chamber 503, from fluid ejection chamber 502. Such objects, if allowed to enter fluid ejection chamber 502 or fluid ejection chamber 503, or fluid circulation channel 520, may affect the performance of fluid ejection device 500, including, for example, the performance of drop ejecting element 504 or drop ejecting element 505, or fluid circulating element 522. In addition, object tolerant architecture 544 helps to increase back pressure and, therefore, increase firing momentum of the ejection of drops from fluid ejection chamber 502 by helping to contain the drive energy during drop ejection. Furthermore, object tolerant architecture 544 helps to mitigate or minimize cross-talk between fluid ejection chamber 502 and fluid ejection chamber 503, and between fluid circulating element 522 and fluid ejection chamber 502.

As illustrated in the examples of FIGS. 2, 3, 4, and 5, respectively, fluid ejection chambers 202 and 203 of fluid ejection device 200 are laterally adjacent to each other, fluid ejection chambers 302 and 303 of fluid ejection device 300 are laterally adjacent to each other, fluid ejection chambers 402 and 403 of fluid ejection device 400 are laterally adjacent to each other, and fluid ejection chambers 502 and 503 of fluid ejection device 500 are laterally adjacent to each other. In addition, nozzle openings or orifices 212 and 213 of fluid ejection device 200 are each of the same shape and the same size, nozzle openings or orifices 312 and 313 of fluid ejection device 300 are each of the same shape and the same size, nozzle openings or orifices 412 and 413 of fluid ejection device 400 are each of the same shape and the same size, and nozzle openings or orifices 512 and 513 of fluid ejection device 500 are each of the same shape and the same size. Accordingly, drop ejecting elements 204 and 205 of fluid ejection device 200, drop ejecting elements 304 and 305 of fluid ejection device 300, drop ejecting elements 404 and 405 of fluid ejection device 400, and drop ejecting elements 504 and 505 of fluid ejection device 500, respectively, may be operated separately or individually at different moments of time to produce separate or individual drops of the same size (weight), or operated concurrently or substantially simultaneously to produce a combined drop of a combined size (weight).

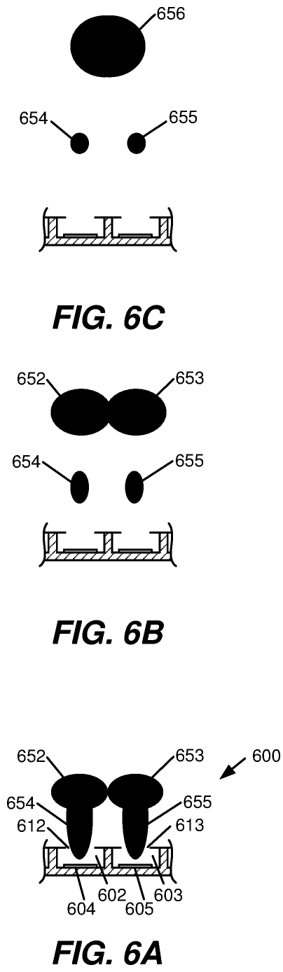

More specifically, in one example, as illustrated in FIGS. 6A, 6B, 6C, laterally adjacent drop ejecting elements 604 and 605 of fluid ejection device 600 (as an example of fluid ejection devices 200, 300, 400, 500) are operated concurrently or substantially simultaneously to produce a combined drop of a combined size (weight). For example, as illustrated in FIG. 6A, concurrent or substantially simultaneous ejection of fluid from fluid ejection chambers 602 and 603 through respective nozzles 612 and 613 (as an example of fluid ejection chambers 202/203, 302/303, 402/403, 502/503 and respective nozzles 212/213, 312/313, 412/413, 512/513) results in individual drops 652 and 653 (with respective tails 654 and 655) being formed. Subsequently, as illustrated in FIG. 6B, individual drops 652 and 653 begin to merge or coalesce during flight (and tails 654 and 655 break off). Thereafter, as illustrated in FIG. 6C, a single, merged drop 656 is formed in flight (with tails 654 and 655 dissipating).

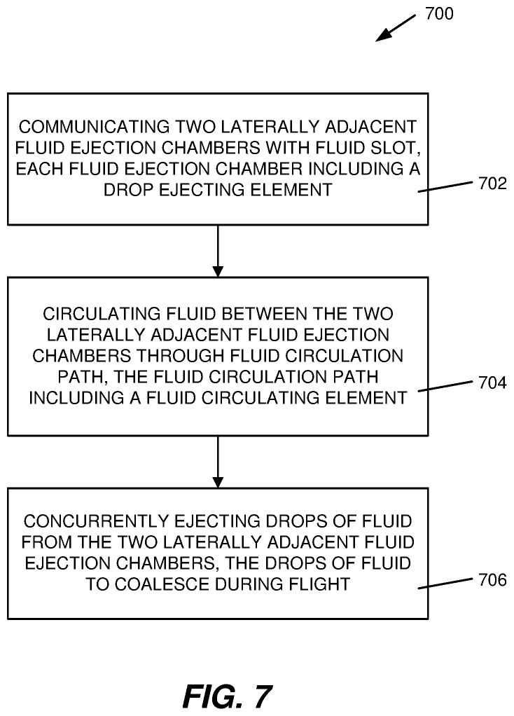

FIG. 7 is a flow diagram illustrating an example of a method 700 of operating a fluid ejection device, such as fluid ejection devices 200, 300, 400, 500 as illustrated in the respective examples of FIGS. 2, 3, 4, 5, and fluid ejection device 600 as illustrated in the example of FIGS. 6A, 6B, 6C.

At 702, method 700 includes communicating two laterally adjacent fluid ejection chambers with a fluid slot, with each of the two laterally adjacent fluid ejection chambers including a drop ejecting element, such as fluid ejection chambers 202/203, 302/303, 402/403, 502/503 including respective drop ejecting elements 204/205, 304/305, 404/405, 504/505 communicating with respective fluid feed slots 208, 308, 408, 508.

At 704, method 700 includes circulating fluid between the two laterally adjacent fluid ejection chambers through a fluid circulation path, with the fluid circulation path including a fluid circulating element, such as circulating fluid between fluid ejection chambers 202/203, 302/303, 402/403, 502/503 through respective fluid circulation paths or channels 220, 320, 420, 520 including respective fluid circulating elements 222, 322, 422, 522.

At 706, method 700 includes concurrently ejecting drops of fluid from the two laterally adjacent fluid ejection chambers, wherein the drops of fluid are to coalesce during flight, such as individual drops 652/653 substantially simultaneously ejecting from respective fluid ejection chambers 602/603 (as an example of fluid ejection chambers 202/203, 302/303, 402/403, 502/503) and combining as merged drop 656.

Although illustrated and described as separate and/or sequential steps, the method may include a different order or sequence of steps, and may combine one or more steps or perform one or more steps concurrently, partially or wholly.

Example fluid ejection devices, as described herein, may be implemented in printing devices, such as two-dimensional printers and/or three-dimensional printers (3D). As will be appreciated, some example fluid ejection devices may be printheads. In some examples, a fluid ejection device may be implemented into a printing device and may be utilized to print content onto a media, such as paper, a layer of powder-based build material, reactive devices (such as lab-on-a-chip devices), etc. Example fluid ejection devices include ink-based ejection devices, digital titration devices, 3D printing devices, pharmaceutical dispensation devices, lab-on-chip devices, fluidic diagnostic circuits, and/or other such devices in which amounts of fluids may be dispensed/ejected.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein.

1. A fluid ejection device, comprising:
a fluid slot;
two laterally adjacent fluid ejection chambers each communicated with the fluid slot and having a drop ejecting element therein; and
a fluid circulation path communicated with each of the two laterally adjacent fluid ejection chambers and having a fluid circulating element therein,
the two laterally adjacent fluid ejection chambers to concurrently eject drops of fluid therefrom, wherein the drops of fluid are to coalesce during flight.

2. The fluid ejection device of claim 1, wherein the fluid circulation path includes a first portion communicated with a first of the two laterally adjacent fluid ejection chambers, a second portion communicated with a second of the two laterally adjacent fluid ejection chambers, and a channel loop between the first portion and the second portion.

3. The fluid ejection device of claim 2, wherein the first portion of the fluid circulation path is to direct fluid in a first direction, and the second portion of the fluid circulation path is to direct fluid in a second direction opposite the first direction.

4. The fluid ejection device of claim 2, wherein the fluid circulating element is within the first portion of the fluid circulation path, and a fluid flow distance between the fluid circulating element and the first fluid ejection chamber is less than a fluid flow distance between the fluid circulating element and the second fluid ejection chamber.

5. The fluid ejection device of claim 2, wherein the fluid circulating element is within the second portion of the fluid circulation path, and a fluid flow distance between the fluid circulating element and the second fluid ejection chamber is less than a fluid flow distance between the fluid circulating element and the first fluid ejection chamber.

6. The fluid ejection device of claim 1, wherein the first fluid ejection chamber has a first end communicated with the fluid slot and a second end opposite the first end communicated with the fluid circulation path, and the second fluid ejection chamber has a first end communicated with the fluid slot and a second end opposite the first end communicated with the fluid circulation path.

7. A fluid ejection device, comprising:
a fluid slot;
a plurality of fluid ejection chambers each communicated with the fluid slot and having a drop ejecting element, including a first fluid ejection chamber having a first drop ejecting element and a second fluid ejection chamber having a second drop ejecting element;
a fluid circulation path communicated with both the first fluid ejection chamber and the second fluid ejection chamber; and
a fluid circulating element within the fluid circulation path,
wherein the first fluid ejection chamber and the second fluid ejection chamber are laterally adjacent to each other and are to substantially simultaneously eject drops of fluid, wherein the drops of fluid are to coalesce in flight.

8. The fluid ejection device of claim 7, wherein the fluid circulation path is to direct fluid in a first direction between the first fluid ejection chamber and the second fluid ejection chamber and in a second direction opposite the first direction between the first fluid ejection chamber and the second fluid ejection chamber.

9. The fluid ejection device of claim 7, wherein the fluid circulation path includes a channel loop, a first portion extended between the first fluid ejection chamber and the channel loop, and a second portion extended between the second fluid ejection chamber and the channel loop.

10. The fluid ejection device of claim 9, wherein the fluid circulation path is to direct fluid in a first direction between the first fluid ejection chamber and the channel loop and in a second direction opposite the first direction between the channel loop and the second fluid ejection chamber.

11. The fluid ejection device of claim 9, wherein the fluid circulating element is within the first portion of the fluid circulation path.

12. The fluid ejection device of claim 9, wherein the fluid circulating element is within the second portion of the fluid circulation path.

13. A method of operating a fluid ejection device, comprising:
communicating two laterally adjacent fluid ejection chambers with a fluid slot, each of the two laterally adjacent fluid ejection chambers including a drop ejecting element;
circulating fluid between the two laterally adjacent fluid ejection chambers through a fluid circulation path, the fluid circulation path including a fluid circulating element; and
concurrently ejecting drops of fluid from the two laterally adjacent fluid ejection chambers, wherein the drops of fluid are to coalesce during flight.

14. The method of claim 13, wherein communicating two laterally adjacent fluid ejection chambers with a fluid slot includes communicating respective first ends of the two laterally adjacent fluid ejection chambers with the fluid slot, and wherein circulating fluid between the two laterally adjacent fluid ejection chambers includes circulating fluid between respective second ends of the two laterally adjacent fluid ejection chambers opposite the respective first ends thereof.

15. The method of claim 13, wherein circulating fluid includes directing fluid in a first direction through a first portion of the fluid circulation path and directing fluid in a second direction opposite the first direction through a second portion of the fluid circulation path.
